(19) United States
(12) Patent Application Publication
(10) Pub. No.: US 2025/0031108 A1
(43) Pub. Date: Jan. 23, 2025

(54) RADIO ACCESS NETWORK NODES WITH WIRELESS COMMUNICATION AND SENSING FOR SINGLE CONNECTIVITY

(71) Applicant: ZTE Corporation, Shenzhen (CN)

(72) Inventors: Li YANG, Shenzhen (CN); Zhiqiang HAN, Shenzhen (CN); Shuqiang XIA, Shenzhen (CN); Feng XIE, Shenzhen (CN)

(73) Assignee: ZTE Corporation, Shenzhen (CN)

(21) Appl. No.: 18/890,913

(22) Filed: Sep. 20, 2024

Related U.S. Application Data
(63) Continuation of application No. PCT/CN2022/098971, filed on Jun. 15, 2022.

(51) Int. Cl. H04W 36/00

(52) U.S. Cl. CPC H04W 36/0069; H04W 36/0085

(57) ABSTRACT

An integrated wireless sensing and communication (ISAC) system may allow for a radio access network (“RAN”) node to improve the sensing. There may be a secondary sensing radio link (S-S-RL) for additional sensing functionality. The sensing signal can be used by the RAN node and/or the UE for detecting objects along a radio path between the RAN node and UE to improve the wireless communication through RL. The S-S-RL may be added in a single connectivity system or may be modified in a dual connectivity system. In order to maximize the sensing collaboration benefits among RAN nodes, the S-S-RL can assist communication or assist sensing.

### CROSS-REFERENCE TO RELATED APPLICATION

This application claims priority as a Continuation to PCT App. No. PCT/CN2022/098971, filed on Jun. 15, 2022, published as WO2023240493A1, entitled “RADIO ACCESS NETWORK NODES WITH WIRELESS COMMUNICATION AND SENSING FOR SINGLE CONNECTIVITY”, the entire disclosure of which is hereby incorporated by reference.

### TECHNICAL FIELD

This document is directed generally to wireless communications. More specifically, a radio access network (“RAN”) node includes secondary wireless sensing from a secondary RAN node that can assist communication and/or assist sensing.

### BACKGROUND

Wireless communication technologies are moving the world toward an increasingly connected and networked society. Wireless communications rely on efficient network resource management and allocation between user mobile stations and wireless access network nodes (including but not limited to radio access network (“RAN”) nodes and wireless basestations). A new generation network is expected to provide high speed, low latency and ultra-reliable communication capabilities and fulfil the requirements from different industries and users. User mobile stations or user equipment (“UE”) are becoming more complex and the amount of data communicated continually increases. With the development of more advanced radar and sensing systems, communications between with the UE can be modernized.

### SUMMARY

This document relates to methods, systems, and devices for a radio access network (“RAN”) node or basestation that provides functionality for wireless sensing (e.g. sensing radio link S-RL) in addition to wireless communications (C-RL). An integrated wireless sensing and communication (SAC) system may allow for the serving RAN node to improve the sensing and/or communication. There may be a secondary sensing radio link (S-S-RL) in secondary RAN node provided that assists with sensing and assists with communication. The sensing signal can be used by the RAN node and/or the UE for detecting objects along a radio path between the RAN node and UE to improve the wireless communication through RL. The S-S-RL may be added in a single connectivity system or may be added or modified in a dual connectivity system. In order to maximize the sensing collaboration benefits among those RAN nodes, the S-S-RL can assist communication or assist sensing in a master RAN node.

In one embodiment, a wireless communication method includes providing an addition request for secondary sensing; and receiving a sensing result report after acknowledging the addition request. The providing is from a master node to a secondary node and the secondary node provides the sensing result report to the master node. A user equipment (UE) in a single connectivity (SC) is changed to a dual connectivity (DC) based on the addition request for secondary sensing. The addition request comprises the secondary sensing to be added to the secondary node. The secondary sensing comprises a secondary sensing radio link or a sensing function conducted by the secondary node. The secondary sensing radio link provides assistance with communication of the master node. The secondary sensing radio link provides assistance with sensing of the master node. The sensing result report is sent periodically. The sensing result report is sent on-demand. The sensing result report includes data that has been sensed by a secondary RAN node.

In another embodiment, a wireless communication method includes receiving an addition request for secondary sensing; providing a sensing result report after acknowledging the addition request. The receiving is from a master node to a secondary node and the secondary node provides the sensing result report to the master node. A user equipment (UE) in a single connectivity (SC) is changed to a dual connectivity (DC) based on the addition request for secondary sensing. The addition request comprises the secondary sensing to be added to the secondary node. The secondary sensing comprises a secondary sensing radio link or a sensing function conducted by the secondary node. The secondary sensing radio link provides assistance with communication of the master node. The secondary sensing radio link provides assistance with sensing of the master node. The sensing result report is sent periodically. The sensing result report is sent on-demand. The sensing result report comprises data that has been sensed by a secondary RAN node.

In one embodiment, a wireless communication method includes providing a modification request for secondary sensing; and receiving a sensing result report after acknowledging the modification request. The providing is from a master node to a secondary node and the secondary node provides the sensing result report to the master node. A user equipment (UE) in a dual connectivity (DC) is modified based on the modification request for secondary sensing. The modification request comprises the secondary sensing to be added or to be modified being provided to the secondary node. The secondary sensing comprises a secondary sensing radio link or a sensing function conducted by the secondary node. The secondary sensing radio link provides assistance with communication of the master node. The secondary sensing radio link provides assistance with sensing of the master node. The sensing result report is sent periodically. The sensing result report is sent on-demand. The sensing result report comprises data that has been sensed by a secondary RAN node.

In another embodiment, a wireless communication method includes receiving a modification request for secondary sensing; and providing a sensing result report after acknowledging the modification request. The receiving is from a master node to a secondary node and the secondary node provides the sensing result report to the master node. A user equipment (UE) in a dual connectivity (DC) is modified based on the modification request for secondary sensing. The modification request comprises the secondary sensing to be added or to be modified being provided to the secondary node. The secondary sensing comprises a secondary sensing radio link or a sensing function conducted by the secondary node. The secondary sensing radio link provides assistance with communication of the master node. The secondary sensing radio link provides assistance with sensing of the master node. The sensing result report is sent periodically. The sensing result report is sent on-demand. The sensing result report comprises data that has been sensed by a secondary RAN node.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a single connectivity wireless communication system.

FIG. 4 shows a dual connectivity wireless communication system,

FIGS. 5A and 5B shows communication with a master node and secondary node that are not located together.

FIG. 5C shows dual connectivity communication with a master node and secondary node that are co-located.

FIG. 6 shows a dual function radio access network (“RAN”) node that communicates with user equipment (“UE”) through the dual functional links.

FIG. 7 shows a communication diagram with a dual function RAN node communication with a communication radio link (“C-RL”) and a sensing radio link (“S-RL”).

FIG. 8 shows a wireless communication system converting from single connectivity to dual connectivity,

FIG. 9 shows a wireless communication system in dual connectivity with an additional secondary sensing radio link (“S-S-RL”).

FIG. 10 shows an embodiment of communications for an addition request with sensing assists communication.

FIG. 11 shows an embodiment of communications for an addition request with sensing assists sensing.

FIG. 12 shows an embodiment of communications for a modification request with sensing assists communication.

FIG. 13 shows another embodiment of communications for a modification request with sensing assists communication.

FIG. 14 shows another embodiment of communications for a modification request with sensing assists communication.

FIG. 15 shows an embodiment of communications for a modification request with sensing assists sensing.

FIG. 16 shows another embodiment of communications for a modification request with sensing assists sensing.

FIG. 17 shows another embodiment of communications for a modification request with sensing assists sensing.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

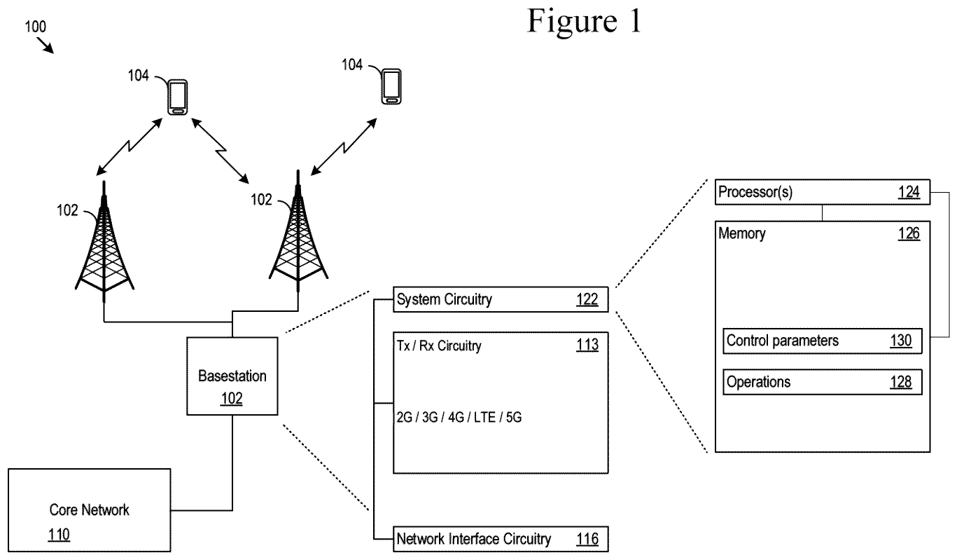

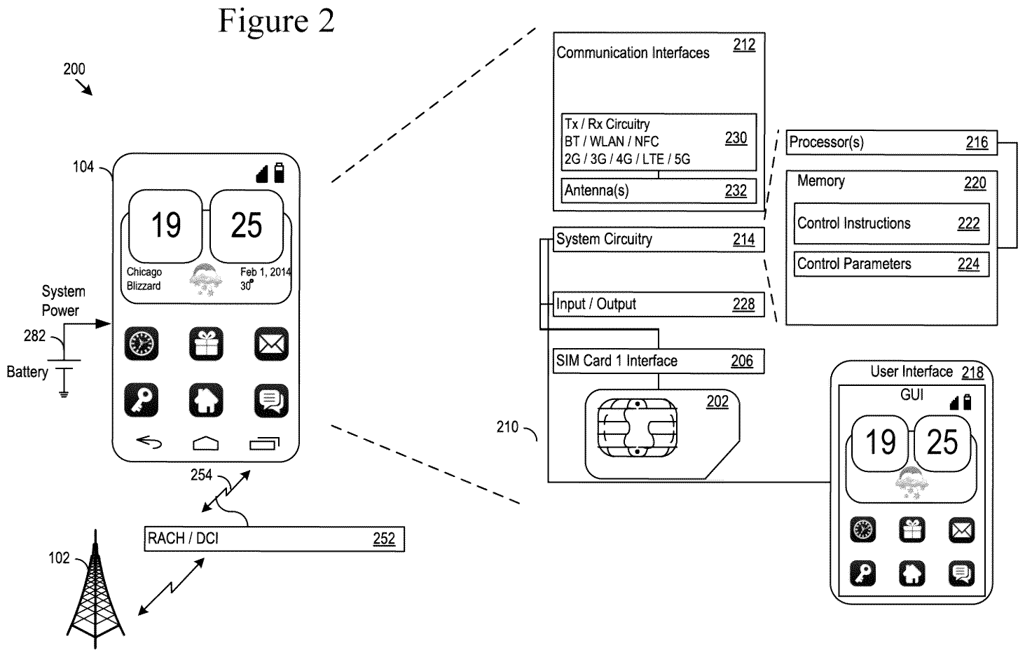

Radio resource control (“RRC”) is a protocol layer between UE and the basestation at the IP level (Radio Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). UE can transmit infrequent (periodic and/or non-periodic) data in RRC_INACTIVE state without moving to an RRC_CONNECTED state. This can save the UE power consumption and signaling overhead. This can be through a Random Access Channel (“RACH”) protocol scheme or a Configured Grant (“CG”) scheme. The wireless communications described herein may be through radio access. In addition, the embodiments described include sensing communications or sensing signals, which are either physically different from wireless communications or logically different from wireless communications. FIGS. 1-2 show example radio access network (“RAN”) nodes (e.g. basestations) and user equipment and messaging environments, which may be applicable to both the wireless communications and sensing communications. A single RAN node is able to provide both wireless communication and wireless sensing capabilities and services more flexibly and efficiently as described herein.

In some wireless communication systems (such as 4G-LTE and 5G-NR), the RAN node may transmit downlink pilot reference signals such as SSB, CSI-RS etc., and the UE receives, measures and processes them so that UE knows the connection quality of the communication radio link (“RL”). This may be conducted between a serving RAN node and the UE in order to maintain mobility and service continuity. The “UE based measurement&report” is one example of sensing configured by network. However, there can be more and different measuring&sensing&report examples between the network and the UE. The network and the UE can measure, detect and sense objects other than pilot reference signals for communications. The sensing may allow for the measure, detection and sensing of a UE's local environments and a UE's resource utilization context. Sensing results may be provided to the UE's serving RAN node, so the serving RAN node can know the UE's local environment and resource utilization context, and dynamically improve the connection quality of the communication RL with the UE.

With the development of International Mobile Telecommunications (IMT) wireless communication systems (such as 4G-LTE and 5G-NR) and various advanced radar and sensing systems, integration may be difficult in terms of architecture/capability design and network/air interface resource usages, etc. Coming iterations of IMT wireless systems in future may integrate and harmonize various wireless sensing functions with their own communication functions, so that the radio access network (RAN) node may provide both wireless communication and wireless sensing capabilities and services.

An integrated wireless sensing and communication (ISAC) system may allow for the serving RAN node to sense the human user body or hand gestures actively based on radar-type sensing techniques. This sensing may be quicker, e.g. 10 ms less latency than other examples (e.g. the legacy UE based measurement report). The serving RAN node can then take more pro-active and quicker actions to boost the connection quality of a radio link (RL). The following are the example RLs and example components described below:
C-RL=communication radio link: the radio link between RAN node and UE, or between RAN nodes, or between UEs, that serve a wireless communication purpose (e.g. transfer data).
S-RL=sensing radio link: the virtual radio link between RAN node and UE, or between RAN node and environment, or between RAN nodes, or between UEs, or between UE and its environment, serving a wireless sensing purpose (e.g. detect and/or sense something).
ISAC RAN node=a RAN node may perform both wireless communication and wireless sensing services.
ISAC RAN node(C)=a RAN node that may only perform wireless communication service (e.g. legacy RAN node).
ISAC RAN node(S)=a RAN node that may only perform wireless sensing service (e.g. radar-type node).
Master ISAC RAN node=the ISAC RAN node playing a master role in a dual connectivity (DC) operation,
Secondary ISAC RAN node=the ISAC RAN node playing a secondary role in DC operation.
M-C-RL=Master C-RL managed by Master ISAC RAN node in DC operation.
M-S-R L=Master S-RL managed by Master ISAC RAN node in DC operation.
S-C-RL=Secondary C-RL managed by Secondary ISAC RAN node in DC operation.
S-S-RL=Secondary S-RL managed by Secondary ISAC RAN node in DC operation.

The RAN node can utilize its ISAC capability to enhance its own wireless communication capability (e.g. improving resource efficiency and saving communication energy etc.). In various networks, there may be RAN nodes that can support multiple network types (or multiple generations of network including 4G, 5G, etc.). Likewise, RAN nodes may support either wireless communication or wireless sensing, or may support both. In order to maximize the sensing collaboration benefits among those RAN nodes, the embodiments described below include additional/secondary sensing that can assist communication or assist sensing in a master RAN node. To achieve “sensing assists communication” or “sensing assists sensing”, wireless sensing collaboration between different RAN nodes is described in the embodiments below. A RAN node can collaborate with other RAN nodes for wireless sensing benefits,

FIG. 1 shows an example (“RAN”) node or basestation 102. The RAN node may also be referred to as a wireless network node. The RAN node 102 may be further identified to as a nodeB (NB, e.g., an eNB or gNB) in a mobile telecommunications context. The example RAN node may include radio Tx/Rx circuitry 113 to receive and transmit with user equipment (UEs) 104. The RAN node may also include network interface circuitry 116 to couple the RAN node to the core network 110, e.g., optical or wireline interconnects, Ethernet, and/or other data transmission mediums/protocols.

The RAN node may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the RAN node. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a RAN node 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the IE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies,

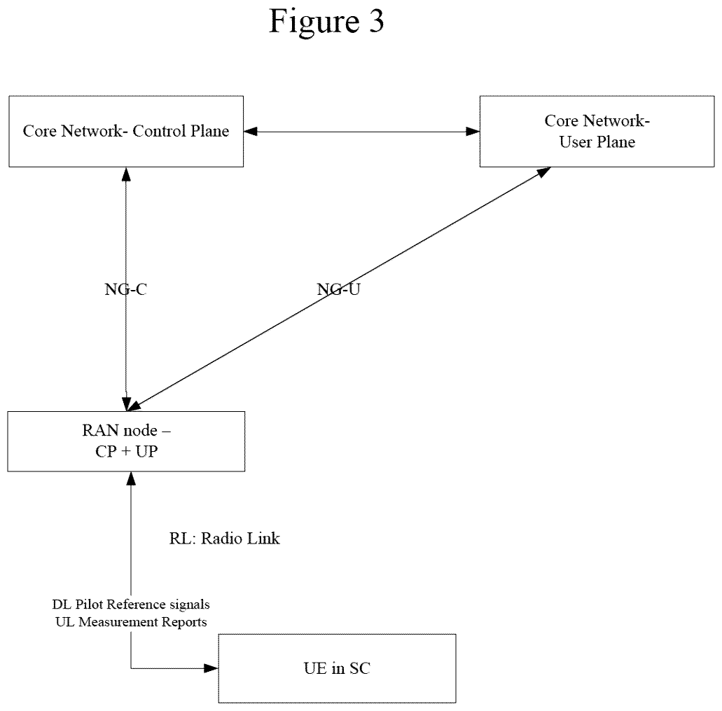

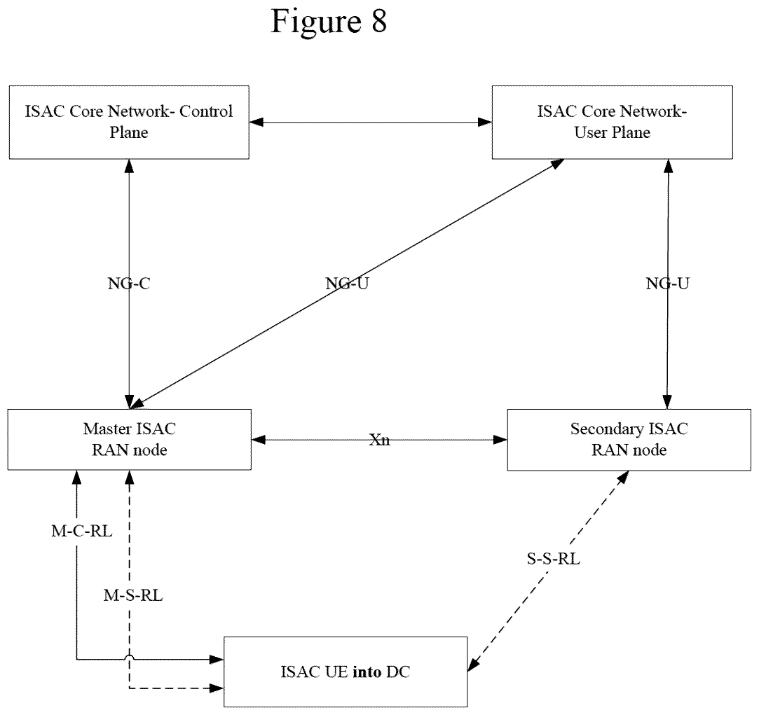

FIG. 3 shows a single connectivity wireless communication system. Single connectivity (SC) may include a UE that only has a master communication radio link (M-C-RL) and/or a master sensing radio link (M-S-RL) but no radio links on the secondary RAN node side. Conversely, dual connectivity (DC) includes a UE with a secondary communication radio link (S-C-RL) and/or a secondary sensing radio link (S-S-RL) on the secondary RAN node side. The SC and DC connectivity is further described below, including with respect to FIG. 8.

In IMT wireless communication systems (such as 4G-LTE and 5G-NR) as shown in FIG. 3, the Radio Access Network (RAN) node may transmit downlink (DL) pilot reference signals such as SSB, CSI-RS etc. The IE receives, measures and processes them so that UE can know the connection quality of radio link (RL) over the air. The UL measurement reports are fed back to the serving RAN node. This may be the communications between the serving RAN node and UE, in order to maintain the communication service continuity. This is an example with single connectivity (SC).

A “UE based DL measurement and UL report” is one example of wireless sensing configured by a RAN. However, there can be more types of wireless sensing between a RAN node and UE or between RAN nodes or between UEs. The RAN and UE can locally measure, detect and sense aspects and objects other than the pilot reference signals for a communication purpose or a sensing purpose. The sensing may be triggered by an upper layer or a third party entity. For example, the LIE can sense its local environment (e.g. user gesture, neighbor objects and radio condition) and resource utilization context (e.g. radio/computing/interference status) via its local sensors. This sensing information can be provided as “sensing result info” to its serving RAN node. Based on the sensing, the serving RAN node can know about the UE's environment and resource utilization context, and can take adaptive measures to enhance the wireless communication with the UE.

In one example, in the mmWave (e.g. above 6 GHz) communication context, due to bigger path-loss and vulnerable mmWave channel conditions in the high frequency band, the human user's body and hand gestures may impose adverse disadvantages towards UE wireless communications, such as sheltering and interfering with the RL. Previously, the serving RAN node would rely on other reactive mechanisms to boost the quality of R L, which are often not quick or prompt enough, as they rely on the time-consuming activities on UE side. With the integrated wireless communication and sensing system in a dual functional RAN node, the serving RAN node may sense and detect the human user body and hand gestures based on either radar type techniques (with a sensing signal) that is identified much more quickly in advance, so the serving RAN node can take proactive actions to boost the quality of the communication RL.

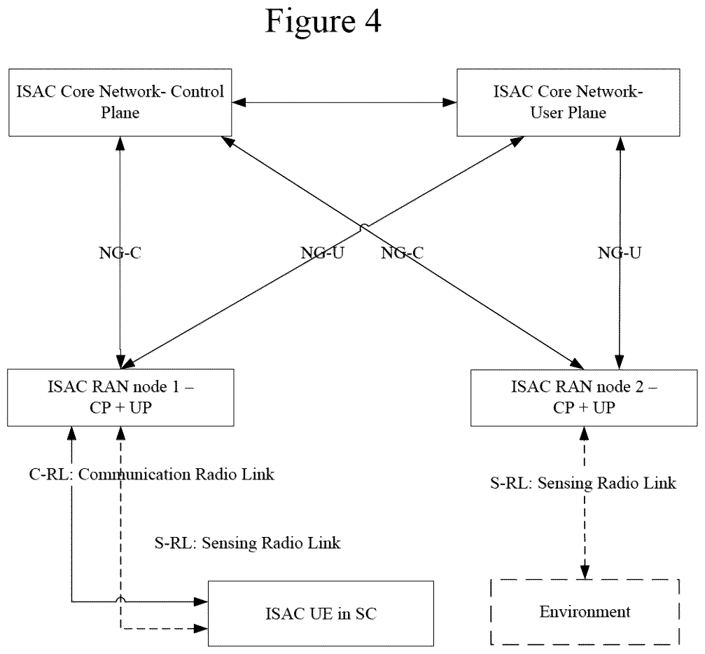

FIG. 4 shows a dual connectivity wireless communication system. Dual connectivity (DC) includes a UE with a secondary communication radio link (S-C-RL) and/or a secondary sensing radio link (S-S-RL). The SC and DC connectivity is further described below, including with respect to FIG. 8. For example, DC operation may include any of the following combinations of X-X-RL:
M-C-RL+M-S-RL;
M-C-RL+S-C-RL;
M-C-RL+S-S-RL;
M-S-RL+S-C-RL;
M-S-RL+S-S-RL; or
S-C-RL+S-S-RL.

In FIG. 4, the UE communicates with the RAN node 1 with both a C-RL and a S-RL. There is a second RAN node that only provides an S-RL towards an environment. The Core Network, RAN node and UE are all ISAC capable in this embodiment. In other words, they are capable of both wireless communication and wireless sensing over the air. The communication radio link is now denoted as “C-RL” still serving communication purpose, while the sensing radio link is denoted as “S-RL” which exists as a logic function but also can be physically implemented together with “C-RL” The ISAC capable RAN node could perform some type of wireless sensing via “S-RL” towards a certain target UE, or it may also perform wireless sensing via “S-RL” towards the environment with assisting UE involvement or without assisting UE involvement.

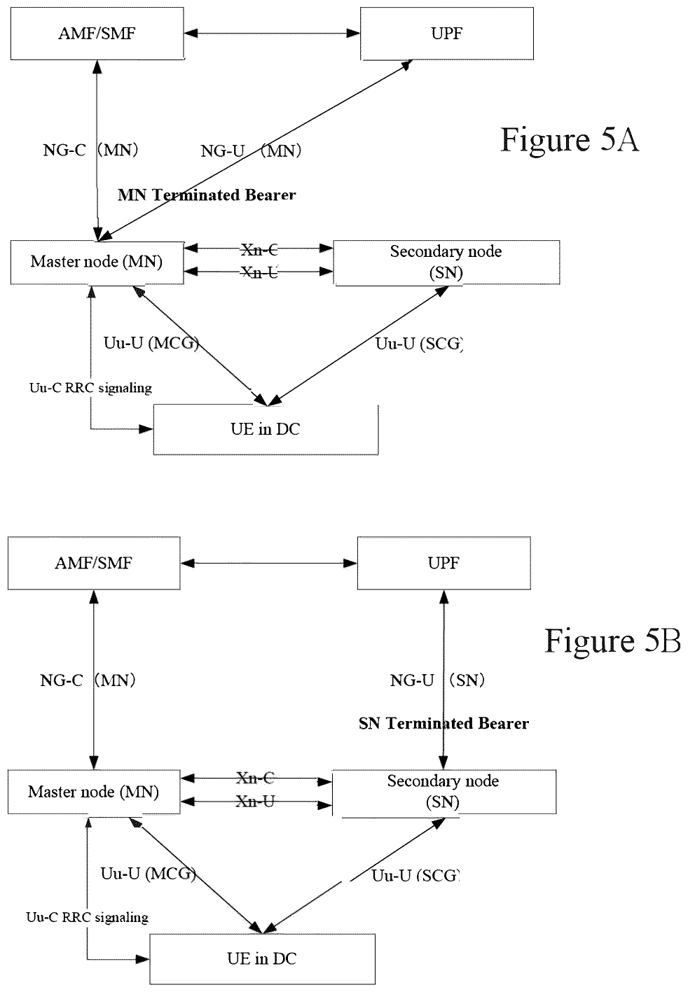

FIGS. 5a and 5b shows communication with a master node and secondary node that are not located together. Multiple RAN nodes of same or different radio access technology (“RAT”) (e.g. eNB, gNB, xNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture with non-co-located master node (“MN”) and secondary node (“SN”) is shown in FIGS. 5a and 5b. Access Mobility Function (“AMF”) and Session Management Function (“SMF”) are the control plane entities and User Plane Function (“UPF”) is the user plane entity in new radio (“NR”) or 5GC. The signaling connection between AMF/SMF and MN is a Next Generation-Control Plane (“NG-C”)/MN interface. The signaling connection between MN and SN is an Xn-Control Plane (“Xn-C”) interface. The signaling connection between MN and UE is a Uu-Control Plane (“Tu-C”) RRC interface. All these connections manage the configuration and operation of MR-DC. FIG. 5a dhows the user plane connection between UPF and MN is NG-U(MN) interface instance, which corresponds to MN terminated bearer,

FIG. 5b shows the user plane connection between UPF and SN is NG-U(SN) interface, which corresponds to SN terminated bearer. The user plane connection between MN and SN is Xn-User Plane (“Xn-U”) interface, which corresponds to split bearer. The user plane connection between MN and UE is Uu-U(MCG) interface instance (providing master RL) and the user plane connection between SN and UE is Uu-U(SCG) interface instance (providing secondary RL). These user plane connections support the user data transfer of MR-DC. From network perspective, MN provides communication service via local processing effort inside MN and MCG resources over Uu-U (MCG); while SN provides communication service in parallel via local processing effort inside SN and SCG resources over Uu-U(SCG) towards the same target TIE. There are two separate and independent RLs (master RL and secondary RL).

FIG. 5c shows communication with a master node and secondary node that are co-located. The MR-DC Architecture with co-located MN and SN is shown in FIG. 5c. Logically, the MN and SN still exist but physically they are now implemented in the same RAN node, so the external Xn interface instance in FIGS. 5a-5b between MN and SN are not needed, and the MN and SN coordinate with each other in an internal interface. There are also two separate and independent RLs (master RL and secondary RL). The single MR-DC functional RAN node shown in FIG. 5c logically integrates primary/master wireless communication RL (M-C-RL) and secondary wireless communication RL (S-C-RL) towards the same target UE. From the MR-DC functional UE perspective, it logically integrates and maintains two separate and independent RLs over the air. Those two RLs may be of the same or different RATs or frequency carriers. From network perspective, MN provides primary wireless communication service via M-C-RL and SN provides secondary wireless communication service via S-C-RL. From a UE in DC perspective, it may be served by two independent communication RLs: Master C-RL and Secondary C-RL over the air,

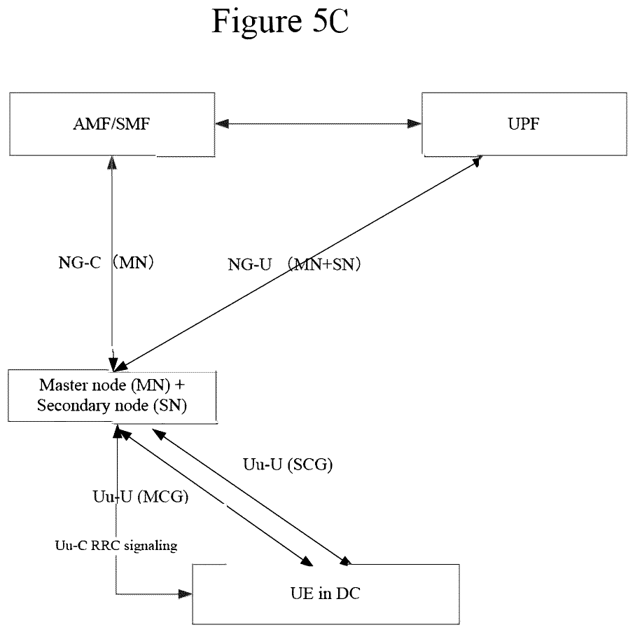

FIG. 6 shows an example radio access network (“RAN”) node that communicates with user equipment (“UE”) through multiple links for a dual function. One of the dual functions is wireless communication and the other is wireless sensing. Wireless communication includes at least one radio link (“C-RL”) for transmitting and receiving (signaling and/or user) data over the air between the RAN node and the UE. Wireless sensing includes a sensing radio link (“S-RL”). The S-RL is setup and used to sense and detect something along a radiation path over the air between the RAN node and the UE. The sensing radio link (“S-RL”) is a logic radio link not used for the purpose of transmitting and receiving (signaling and/or user) data over the air, but is used for the purpose of sensing and detecting something along the radiation path over the air. The dual function RAN node includes a single RAN node which can perform both wireless communication and wireless sensing operations with the target UE. Specifically, FIG. 6 illustrates the dual function RAN node sends a sensing radio link (“S-RL”) to the UE, which then returns a signal (e.g. an echo signal/response) to the RAN node. In addition to the wireless sensing of the S-RL, the dual function RAN node has a communication radio link (“C-RL”). The C-RL is a downlink from the RAN node to the UE and an uplink from the UE to the RAN node. As shown in FIG. 6, the dual function RAN node can setup and maintain both S-RL and C-RL with the target UE simultaneously. For the handling of communication C-RL, it may be the same as legacy systems (e.g. following the specifications of 4G-LTE or 5G-NR).

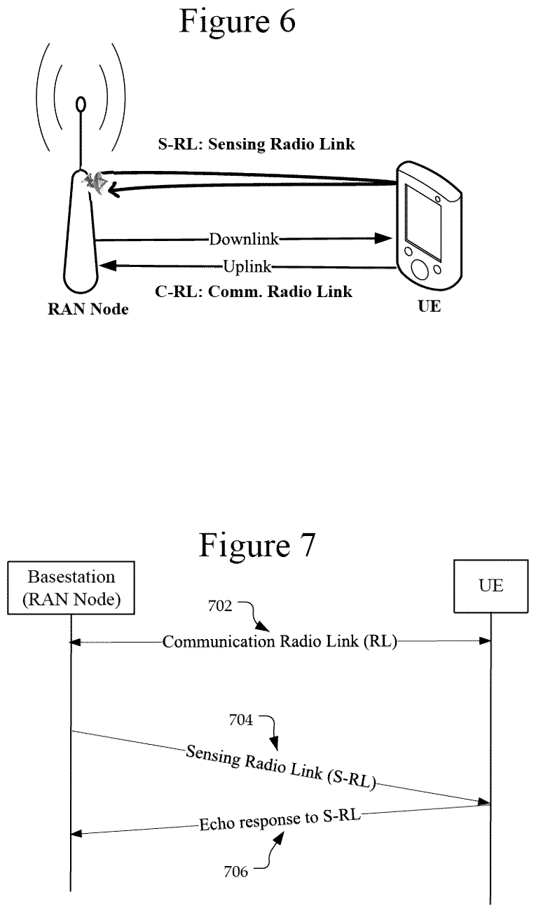

FIG. 7 shows a communication diagram with a dual function RAN node communication with a communication radio link (“C-RL”) and a sensing radio link (“S-RL”). The RAN node (also referred to as a basestation) establishes a communication C-RL 702 with the UE. In addition, the second function of the RAN node provides an S-RL 704 to the UE. In response to the S-RL 704, the UE provides a response 706. The response 706 may be referred to as an echo signal that transmitted by the UE in direct response to receipt to the S-RL 704 as part of the sensing operation S-RL. S-RL may be a logically separated radio link from the communication C-RL, but physically S-RL may share the same or use different air/radio resources (e.g. time/frequency/space/code etc.) from the communication C-RL's. FIG. 7 shows an example of using different air/radio resources, where the radio signal between RAN node and UE carries either the data information or the sensing related information, but not both in this embodiment.

### Secondary Sensing

The IMT 5G-Advanced (5G-A) and future wireless systems may integrate and harmonize various wireless sensing functions with their own communication functions, so that the RAN node is able to provide both wireless communication and wireless sensing capabilities and/or services; one of such integration (ISAC) benefits is that the RAN node can utilize its own wireless sensing capability to enhance its own wireless communication capability, e.g. improving resource efficiency and saving communication energy etc. Despite of such integration trend, in heterogeneous network or for any business reason, there will be still lots of RAN nodes that can support both or can only support either wireless communication or wireless sensing capability in field. In order to maximize the sensing collaboration benefits among those RAN nodes, e.g. to achieve the performance gains from“sensing assists communication” and “sensing assists sensing”, method for wireless sensing collaboration between different RAN nodes is needed. This patent aims to create new mechanism, modeling and method to tackle such issue, so that the “Requesting” RAN node could inter-work and collaborate with other “Assisting” RAN node for any kind of wireless sensing benefits.

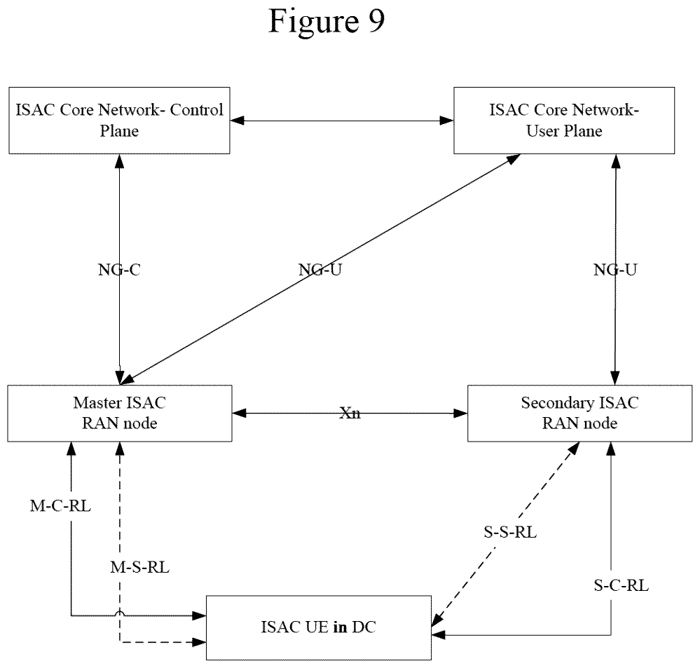

FIG. 8 shows a wireless communication system converting from single connectivity to dual connectivity. There is direct interface (denoted as Xn) between two ISAC RAN nodes, and they can inter-work and/or collaborate with each other via various Xn procedures for at least:
Coordination of wireless communication capability, resource and operation status of both sides;
Coordination of wireless sensing capability, resource and operation status of both sides; and/or
Management of DC operation.
For a UE in SC mode, the current serving RAN node (to become Master ISAC RAN node) may be allowed to add Secondary ISAC RAN node for:
a wireless sensing purpose (only addition with new S-S-RL without S-C-RL) [as shown in FIG. 8];
a wireless communication purpose (only addition with new S-C-RL without S-S-RL); or
both wireless communication and wireless sensing purpose (addition with both new S-S-RL and S-C-RL) [compare with FIG. 9].

FIG. 8 shows a collaboration between different ISAC RAN nodes into UE DC mode. Specifically, this embodiment may refer to the case that UE changes from “SC mode” into “DC mode.” The SN is added in FIG. 8. Compared with FIG. 4, S-S-RL alone may not be enough (MN only needs S-S-RL assistance from SN at the moment, but not S-C-RL. In another embodiment, there may be a S-S-RL+S-C-RL as well. As shown in FIG. 8, the Master ISAC RAN node has setup and maintain M-C-RL with the target UE for wireless communication purpose. Optionally, there may be a M-S-RL with the same UE, in order to achieve some type of wireless sensing benefits, (e.g. the Master ISAC RAN node may achieve a benefit of “sensing assists communication” via local M-S-RL). The additional/secondary sensing may provide assistance with communications (i.e. “sensing assists communication”) and/or provide assistance with sensing (i.e. “sensing assists sensing”).

For the “sensing assists communication”, the sensing operation of S-S-RL assists the communication operation of M-C-RL. The Master ISAC RAN node may determine that the local M-S-RL (if configured) is not sufficient (e.g. no sufficient wireless sensing benefit of “sensing assists communication” via local M-S-RL), so the Master ISAC RAN node triggers the “Secondary ISAC RAN node Addition Procedure” over Xn interface, to request the Secondary ISAC RAN node to setup and maintain S-S-RL. The Secondary ISAC RAN node may setup and maintain S-S-RL and perform the requested wireless sensing operations via S-S-RL with the target UE. Feedback is provided for the “sensing result info” to the Master ISAC RAN node via “ISAC RAN node Sensing Result Report Procedure” over Xn interface. Upon obtaining the “sensing result info”, the Master ISAC RAN node may interpret, compile, and/or use them and attempt to achieve an additional wireless sensing benefit of “sensing assists communication” from the S-S-RL.

For the “sensing assists sensing”, the sensing operation of S-S-RL assists the sensing operation of M-S-RL. The Master ISAC RAN node may determine that the local M-S-RL (if configured) is not sufficient (e.g. no sufficient wireless sensing related performance via local M-S-RL), so the Master ISAC RAN node triggers the “Secondary ISAC RAN node Addition Procedure” over Xn interface, to request the Secondary ISAC RAN node to setup and maintain S-S-RL. The Secondary ISAC RAN node may setup and maintain S-S-RL and perform the requested wireless sensing operations via S-S-RL with the target UE. Feedback is provided for the “sensing result info” to the Master ISAC RAN node via “ISAC RAN node Sensing Result Report Procedure” over Xn interface. Upon obtaining the “sensing result info”, the Master ISAC RAN node may interpret, compile, and/or use them to improve its sensing related performance and attempt to achieve additional wireless sensing benefit of “sensing assists sensing” from the S-S-RL,

FIG. 9 shows a wireless communication system in dual connectivity with an additional secondary sensing radio link (“S-S-RL”). FIG. 8 illustrated a SC example, while FIG. 9 is a DC example. For a UE already in DC mode (e.g. already has at least S-C-RL or S-S-RL), the Master ISAC RAN node may be allowed to modify the Secondary ISAC RAN node as follows:
for wireless sensing purpose (e.g. addition with new S-S-RL);
for wireless communication purpose (e.g. addition with new S-C-RL);
for wireless sensing purpose (e.g. modification with existing S-S-RL);
for wireless communication purpose (e.g. modification with existing S-C-RL); and/or
for both wireless communication and wireless sensing purpose (e.g. modification with both existing S-S-RL and S-C-RL).

FIG. 9 illustrates collaboration between different ISAC RAN nodes in UE DC mode. In this embodiment, the UE is already in “DC mode”, as S-C-RL on the SN side has been established, but S-S-RL has not yet been established. The MN can then use assistance from the S-S-RL. In FIG. 9, the Master ISAC RAN node has setup and maintains M-C-RL with the target UE for wireless communication purpose. Optionally, it has setup and maintains M-S-RL with the same UE, in order to achieve some form of wireless sensing benefits. For example, the Master ISAC RAN node may achieve a benefit of “sensing assists communication” via local M-S-RL. The Secondary ISAC RAN node has setup and maintains S-C-RL with the target UE for wireless communication purposes. Optionally, it has setup and maintains S-S-RL with the same UE, in order to achieve some type of wireless sensing benefits. For example, the Secondary ISAC RAN node may achieve a benefit of “sensing assists communication” via local S-S-RL.

For the “sensing assists communication” in DC operation, the sensing operation of S-S-RL assists the communication operation of M-C-RL. The Master ISAC RAN node determines whether the local M-S-RL is sufficient. If there is not a sufficient wireless sensing benefit of “sensing assists communication” via local M-S-RL, then the Master ISAC RAN node triggers the “Secondary ISAC RAN node Modification Procedure” over Xn interface. This can request the Secondary ISAC RAN node to setup or modify S-S-RL. The Secondary ISAC RAN node may setup or modify S-S-RL and perform the requested wireless sensing operations via S-S-RL with the target UE. Feedback of the “sensing result info” is provided to the Master ISAC RAN node via “ISAC RAN node Sensing Result Report Procedure” over Xn interface. Upon obtaining the “sensing result info”, the Master ISAC RAN node may interpret, compile, and/or use them to attempt to achieve an additional wireless sensing benefit of “sensing assists communication” from S-S-RL.

For the “sensing assists sensing” in DC operation, the sensing operation of S-S-RL assists the sensing operation of M-S-RL. The Master ISAC RAN node determines whether the local M-S-R L is sufficient. If there is not a sufficient wireless sensing performance via local M-S-RL, the Master ISAC RAN node triggers the “Secondary ISAC RAN node Modification Procedure” over Xn interface. This requests the Secondary ISAC RAN node to setup and or modify S-S-RL. The Secondary ISAC RAN node may setup or modify S-S-RL and perform the requested wireless sensing operations via S-S-RL with the target UE. Feedback of the “sensing result info” is provided to the Master ISAC RAN node via “ISAC RAN node Sensing Result Report Procedure” over Xn interface. Upon obtaining the “sensing result info”, the Master ISAC RAN node may interpret, compile, and/or use them to improve wireless sensing related performance and attempt to achieve additional wireless sensing benefits of “sensing assists sensing” from the S-S-RL.

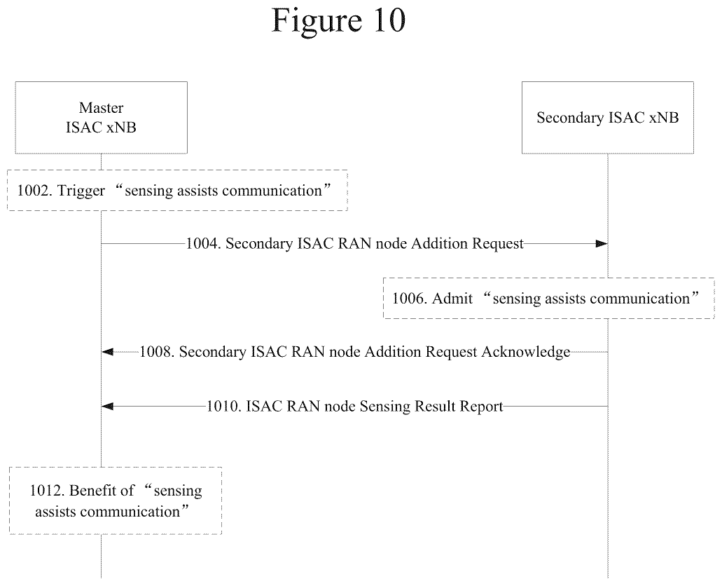

FIG. 10 shows an embodiment of communications for an addition request with sensing assists communication. The Master ISAC xNB has setup and maintain M-C-RL (e.g. in 3.5 GHz band) with the target UE for wireless communications, and also setup and maintain M-S-RL (e.g. in 6 GHz band) with the same UE for wireless sensing. The M-S-RL is based on a radar-type sensing mechanism that is implemented by Master ISAC xNB and can be used to enhance the MIMO beam management between xNB and UE. For example, the xNB can optimize the serving beam selection for M-C-RL in advance based on a radar-type sensing feedback. This achieves the benefit of “sensing assists communication” via local M-S-RL. The Master ISAC xNB may coordinate with other neighbor ISAC xNB(s) about their mutual wireless sensing capability, resource, and operation status.

The Master ISAC xNB may determine that the local M-S-RL is not sufficient. For example, there may be insufficient wireless sensing benefit for MIMO beam management, so the Master ISAC xNB triggers the “Secondary ISAC RAN node Addition Procedure” over Xn interface in block 1002. Sending “Secondary ISAC RAN node Addition Request” message towards Secondary ISAC xNB includes the necessary parameter info (e.g. expected sensing frequency band 26 GHz, “sensing result info” report pattern and wireless sensing signal pattern etc.) for configuring “assisting S-S-RL.”

In block 1004, the Secondary ISAC xNB admits the request from Master ISAC xNB, so the Secondary ISAC xNB may setup and maintain S-S-RL (e.g. in 26 GHz band), and replies to the “Secondary ISAC RAN node Addition Request Acknowledge” message in block 1006 towards the Master ISAC xNB over Xn interface. It may further perform the requested wireless sensing operations via S-S-RL (e.g. in 26 GHz band) with the target UE. In block 1008, after obtaining some “sensing result info”, the Secondary ISAC xNB provides feedback for the “sensing result info.” This may be provided periodically to the Master ISAC xNB via “ISAC RAN node Sensing Result Report Procedure” over Xn interface. In an alternative embodiment, the report may be sent once or together, rather than periodically. When sent periodically, there may continuous benefits (e.g. block 1012). In block 1010, the “ISAC RAN node Sensing Result Report” message is sent towards the Master ISAC xNB, containing the available “sensing result info.”

In block 1012, upon obtaining the “sensing result info”, the Master ISAC xNB may interpret, compile, and use them to assist the serving beam selection for M-C-RL and attempt to achieve additional wireless sensing benefit of “sensing assists communication” from S-S-RL. The Secondary ISAC xNB continues to perform wireless sensing towards the target UE via S-S-RL and report the available “sensing result info” periodically to the Master ISAC xNB, until it is indicated to stop by either Master ISAC xNB command or itself for any reason.

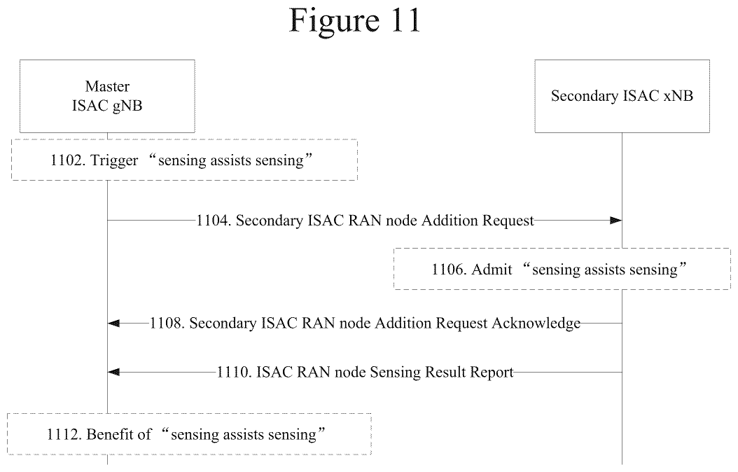

FIG. 11 shows an embodiment of communications for an addition request with sensing assists sensing. The Master ISAC gNB may setup and maintain M-C-RL (e.g. in 2.6 GHz band) with the target UE for a wireless communication purpose. I may also setup and maintain M-S-RL (e.g. in 2.6 GHz band) with the same UE for a wireless sensing purpose. The M-S-RL may be based on a radar-type mechanism implemented by Master ISAC gNB and can be used to measure and/or evaluate the target UP's position and trajectory. For example, the gNB can predict IE's mobility profile in advance based on radar-type sensing feedback, and to achieve a benefit of “sensing assists sensing” via local M-S-RL. The Master ISAC gNB may coordinate with other neighbor ISAC xNB(s) about their mutual wireless sensing capability, resource, and operation status.

The Master ISAC gNB may determine whether the local M-S-RL is sufficient, including a sufficiency of performance for IE positioning accuracy. In block 1102, the Master ISAC gNB triggers the “Secondary ISAC RAN node Addition Procedure” over Xn interface. This may include sending “Secondary ISAC RAN node Addition Request” message towards Secondary ISAC xNB in block 1104. This may further include parameter info (e.g. expected sensing frequency band 60 GHz) a “sensing result info” report pattern and wireless sensing signal pattern for configuring the “assisting S-S-RL.” In block 1106, the Secondary ISAC xNB admits the request from Master ISAC gNB, so the Secondary ISAC xNB may setup and maintain S-S-RL (e.g. in 60 GHz band), and also replies the “Secondary ISAC RAN node Addition Request Acknowledge” message in block 1108 towards the Master ISAC gNB over Xn interface, and further performs the requested wireless sensing operations via S-S-RL (e.g. in 60 GHz band) with the target UE.

After obtaining “sensing result info”, the Secondary ISAC xNB may provide feedback for the “sensing result info.” This may be provided (once, intermitted, or periodically) to the Master ISAC gNB via “ISAC RAN node Sensing Result Report Procedure” over Xn interface in block 1110. This may include sending “ISAC RAN node Sensing Result Report” message in block 1110 towards the Master ISAC gNB, including the available “sensing result info.” Upon obtaining the “sensing result info”, the Master ISAC gNB may interpret, compile, and use them to assist the evaluation of the target UE's position and trajectory and attempt to achieve additional wireless sensing benefit of “sensing assists sensing” from S-S-RL in block 1112. The Secondary ISAC xNB continues to perform wireless sensing towards the target UE via S-S-RL and report the available “sensing result info” periodically to the Master ISAC gNB, until it is indicated to stop by either Master ISAC gNB command or itself for any reason. In an alternative embodiment, the report may be sent once or together, rather than periodically.

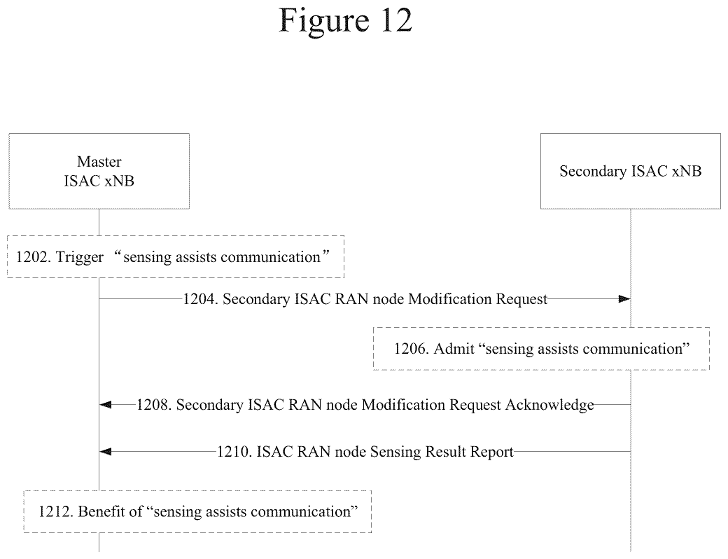

FIG. 12 shows an embodiment of communications for a modification request with sensing assists communication. In FIG. 12, the S-S-RL must be setup. The Master ISAC xNB and Secondary ISAC xNB setup and maintain M-C-RL and S-C-RL respectively (e.g. in 3.5 GHz band) with the target UE for wireless communication purpose. The Master ISAC xNB has also setup and maintains M-S-RL (e.g. in 6 GHz band with the same UE for a wireless sensing purpose. The M-S-RL may be based on radar-type mechanism implemented by Master ISAC xNB and can be used to enhance the MIMO beam management between xNB and UE. For example, xNB may optimize the serving beam selection for M-C-RL in advance based on radar-type sensing feedback. This may achieve the benefit of “sensing assists communication” via local M-S-RL. The Master ISAC xNB may coordinate with the Secondary ISAC xNB about their mutual wireless sensing capability, resource, and operation status.

The Master ISAC xNB determines whether the local M-S-RL is sufficient. This may include determining whether there is a sufficient wireless sensing benefit for MIMO beam management. The Master ISAC xNB triggers the “Secondary ISAC RAN node Modification Procedure” over Xn interface in block 1202. This may include sending “Secondary ISAC RAN node Modification Request” message in block 1204 towards the Secondary ISAC xNB, including the necessary parameter info (e.g. expected sensing frequency band 26 GHz), such as the “sensing result info” report pattern and wireless sensing signal pattern for configuring “assisting S-S-RL.”

The Secondary ISAC xNB admits the request from Master ISAC xNB in block 1206, so the Secondary ISAC xNB shall setup and maintain S-S-RL (e.g. in 26 GHz band). In block 1208, it replies the “Secondary ISAC RAN node Modification Request Acknowledge” message towards the Master ISAC xNB over Xn interface, and further performs the requested wireless sensing operations via S-S-RL (e.g. in 26 GHz band) with the target UE. After obtaining some “sensing result info”, the Secondary ISAC xNB feeds back the “sensing result info” to the Master ISAC xNB via “ISAC RAN node Sensing Result Report Procedure” over Xn interface in block 1210. This may include sending “ISAC RAN node Sensing Result Report” message towards the Master ISAC xNB, including the available “sensing result info.” Upon obtaining the “sensing result info”, the Master ISAC xNB shall interpret, compile, and/or use them to assist the serving beam selection for M-C-RL and attempt to achieve additional wireless sensing benefit of “sensing assists communication” from S-S-RL in block 1212. In some embodiments, the sensing result report is periodically provided, so the benefits of block 1212 continue. Specifically, the Secondary ISAC xNB continues to perform wireless sensing towards the target UE via S-S-RL and reports the available “sensing result info” periodically to the Master ISAC xNB, until it is indicated to stop by either Master ISAC xNB command or itself for any reason.

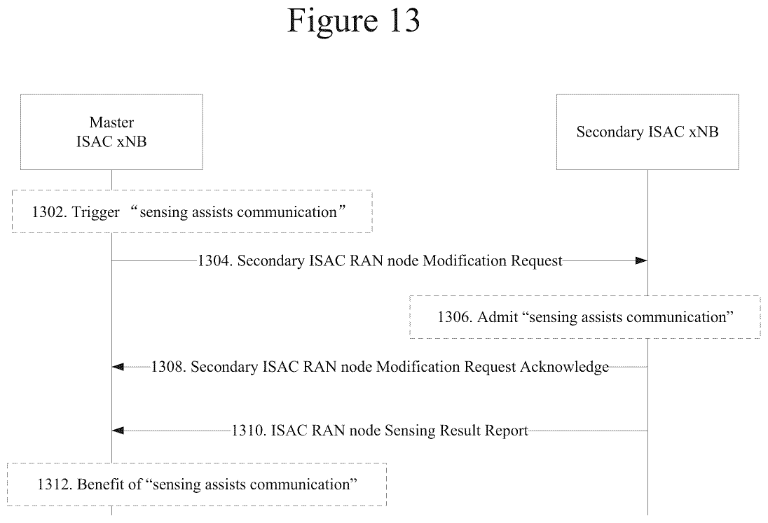

FIG. 13 shows another embodiment of communications for a modification request with sensing assists communication. FIG. 13 illustrates an embodiment in which the S-S-RL was already setup and already exists, but now must be modified. This embodiment modifies the existing S-S-RL. The Master ISAC xNB and Secondary ISAC xNB have already setup and continue to maintain M-C-RL and S-C-RL respectively (e.g. in 3.5 GHz band) with the target UE for wireless communication purpose. The Secondary ISAC xNB has also setup and maintains S-S-RL (e.g. in 26 GHz band) with the same LIE for a wireless sensing purpose. The S-S-RL may be based on a radar-type mechanism implemented by the Secondary ISAC xNB and can be used to enhance the MIMO beam management between the Master ISAC xNB and UE. For example, the Master ISAC xNB can optimize the serving beam selection for M-C-RL in advance based on sensing feedback from the Secondary ISAC xNB. This may achieve the benefit of “sensing assists communication” via S-S-RL. The Master ISAC xNB may coordinate with the Secondary ISAC xNB about their mutual wireless sensing capability, resource, and operation status.

The Master ISAC xNB determines whether the S-S-RL is sufficient. If it is not sufficient, then there is no wireless sensing benefit for MIMO beam management and the Master ISAC xNB triggers the “Secondary ISAC RAN node Modification Procedure” over Xn interface in block 1302. This may include sending “Secondary ISAC RAN node Modification Request” message in block 1304 towards the Secondary ISAC xNB, which includes the updated parameter info (e.g. expected new sensing frequency band 38 GHz, a “sensing result info” report pattern and/or a wireless sensing signal pattern etc.) for reconfiguring the “assisting S-S-RL.”

The Secondary ISAC xNB admits the request from Master ISAC xNB in block 1306, so the Secondary ISAC xNB may setup and maintain S-S-RL (e.g. in 38 GHz band). It replies the “Secondary ISAC RAN node Modification Request Acknowledge” message in block 1308 towards the Master ISAC xNB over Xn interface, and further performs the requested wireless sensing operations via S-S-RL (e.g. in 38 GHz band) with the target UE. In this embodiment, the S-S-RL already exists and is already setup, but it is modified. Other embodiments include creating and/or setting up the S-S-RL.

After obtaining some “sensing result info”, the Secondary ISAC xNB feeds back the “sensing result info” e.g. periodically to the Master ISAC xNB via “ISAC RAN node Sensing Result Report Procedure” over Xn interface. Specifically, the sending of an “ISAC RAN node Sensing Result Report” message in block 1310 to the Master ISAC xNB, including the available “sensing result info,” Upon obtaining the “sensing result info”, the Master ISAC xNB may interpret, compile, and/or use them to assist the serving beam selection for M-C-RL and attempt to achieve additional wireless sensing benefit of “sensing assists communication” from S-S-RL in block 1312. In some embodiments with periodic sending of the sensing result report, the Secondary ISAC xNB continues to perform wireless sensing to the target UE via S-S-RL and reports the available “sensing result info” periodically to the Master ISAC xNB, until it is indicated to stop by either Master ISAC xNB command or itself for any reason. In such an embodiment, the benefits of “sensing assist communication” continue.

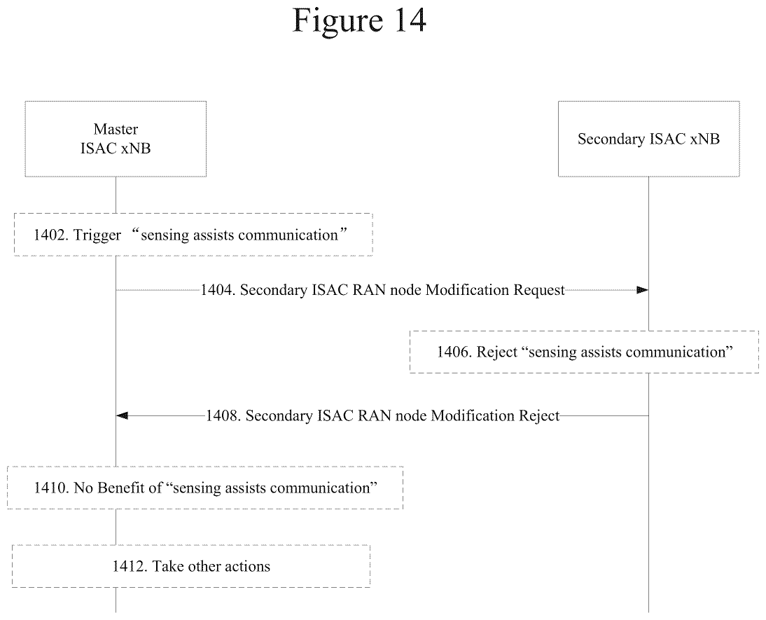

FIG. 14 shows another embodiment of communications for a modification request with sensing assists communication. The Master ISAC xNB and Secondary ISAC xNB have setup and maintain M-C-RL and S-C-RL respectively (e.g. in 3.5 GHz band) with the target UE for a wireless communication purpose. The Secondary ISAC xNB has also setup and maintains S-S-RL (e.g. in 26 GHz band) with the same UE for a wireless sensing purpose. The S-S-RL may be based on a radar-type mechanism implemented by the Secondary ISAC xNB that can be used to enhance the MIMO beam management between the Master ISAC xNB and UE. For example, the Master ISAC xNB may optimize the serving beam selection for M-C-RL in advance based on sensing feedback from the Secondary ISAC xNB. This may achieve the benefit of “sensing assists communication” via S-S-RL. The Master ISAC xNB may coordinate with the Secondary ISAC xNB about their mutual wireless sensing capability, resource, and operation status.

The Master ISAC xNB determines whether the S-S-RL is sufficient. If it is not sufficient, then there is a wireless sensing benefit for MIMO beam management, so the Master ISAC xNB triggers the “Secondary ISAC RAN node Modification Procedure” over Xn interface in block 1402. This may include sending a “Secondary ISAC RAN node Modification Request” message in block 1404 to the Secondary ISAC xNB, including the necessary updated parameter info (e.g. expected new sensing frequency band 38 GHz, a “sensing result info” report pattern, and/or a wireless sensing signal pattern etc.) for reconfiguring the “assisting S-S-RL.”

In this embodiment, if the Secondary ISAC xNB rejects the request from Master ISAC xNB for local resource reasons as in block 1406, it provides the “Secondary ISAC RAN node Modification Reject” message in block 1408 to the Master ISAC xNB over Xn interface. It then stops performing wireless sensing operations via existing S-S-RL (e.g. in 26 GHz band) with the target UE, so no benefit is provided in block 1410. Upon receiving the “Secondary ISAC RAN node Modification Reject” message, the Master ISAC xNB knows about the failure of reconfiguring “assisting S-S-RL” attempt with the Secondary ISAC xNB, and may then take further other actions in block 1412.

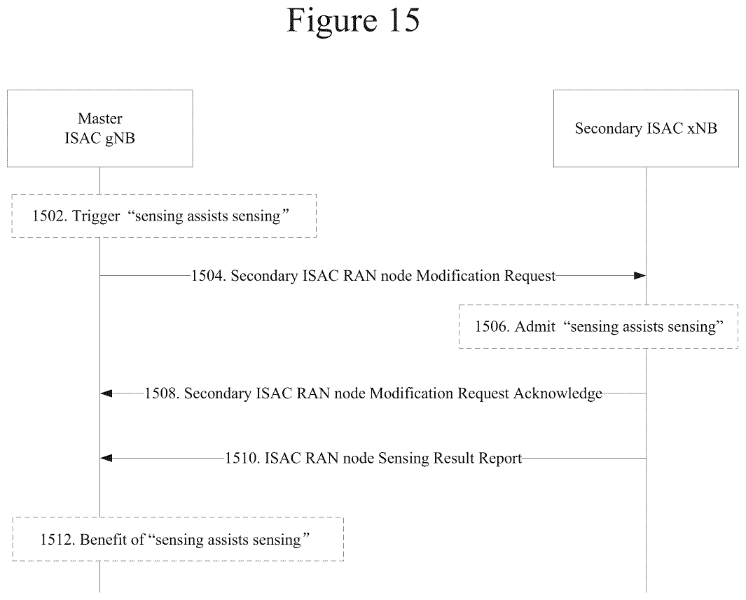

FIG. 15 shows an embodiment of communications for a modification request with sensing assists sensing. The Master ISAC gNB and Secondary ISAC xNB have setup and maintain M-C-RL and S-C-RL respectively (e.g. in 60 GHz band) with the target UE for a wireless communication purpose. The Master ISAC gNB has also setup and maintains M-S-RL (e.g. in 60 GHz band) with the same UE for a wireless sensing purpose. The M-S-RL may be based on a radar-type mechanism implemented by the Master ISAC gNB that can be used to enhance UE imaging management between gNB and UE. For example, the Master ISAC gNB can monitor the UE images based on a radar-type sensing feedback. This may achieve the benefit of “sensing assists sensing” via local M-S-RL. The Master ISAC gNB may coordinate with the Secondary ISAC xNB about their mutual wireless sensing capability, resource, and operation status.

The Master ISAC gNB determines whether the local M-S-RL is sufficient. If not, then there is not a wireless sensing benefit for UE imaging management, and the Master ISAC gNB then triggers the “Secondary ISAC RAN node Modification Procedure” over Xn interface in block 1502. This may include sending “Secondary ISAC RAN node Modification Request” message in block 1504 to the Secondary ISAC xNB. It may include parameter info (e.g. expected sensing frequency band 600 GHz, “sensing result info” report pattern, and/or a wireless sensing signal pattern etc.) for configuring “assisting S-S-RL.”

The Secondary ISAC xNB admits the request from Master ISAC gNB in block 1506, so the Secondary ISAC xNB may setup and maintain S-S-RL (e.g. in 600 GHz band), and replies the “Secondary ISAC RAN node Modification Request Acknowledge” message in block 1508 to the Master ISAC gNB over Xn interface. It may further perform the requested wireless sensing operations via S-S-RL (e.g. in 6000-z band) with the target UE.

After obtaining the “sensing result info”, the Secondary ISAC xNB feeds back the “sensing result info” to the Master ISAC gNB via “ISAC RAN node Sensing Result Report Procedure” over Xn interface. This may include sending “ISAC RAN node Sensing Result Report” message in block 1510 to the Master ISAC gNB and include the available “sensing result info,” Upon obtaining the “sensing result info”, the Master ISAC gNB may interpret, compile, and use them to assist the UE imaging and attempt to achieve an additional wireless sensing benefit of “sensing assists sensing” from S-S-RL in block 1512. The Secondary ISAC xNB continues to perform wireless sensing towards the target UE via S-S-RL and report the available “sensing result info” to the Master ISAC gNB, until it is indicated to stop by either the Master ISAC gNB command or itself for any reason.

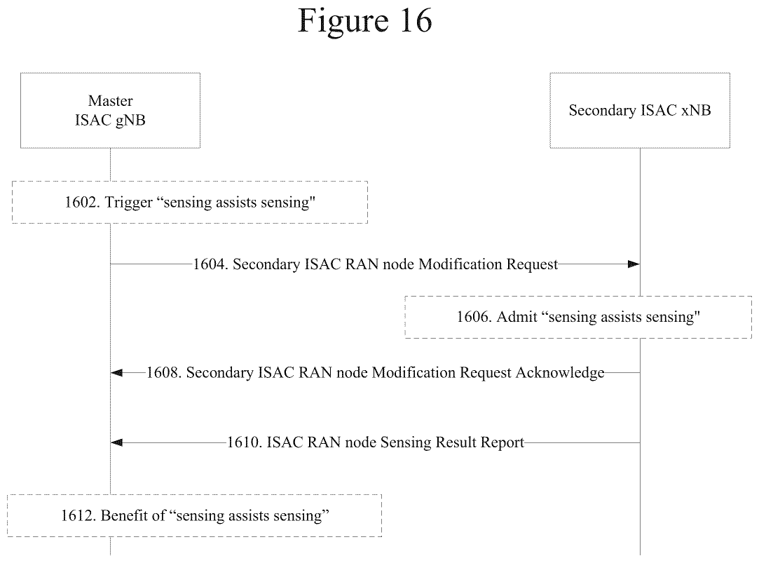

FIG. 16 shows another embodiment of communications for a modification request with sensing assists sensing. FIG. 16 illustrates an embodiment in which the S-S-RL was already setup, but is now modified. The Master ISAC gNB and Secondary ISAC xNB have setup and maintain M-C-RL and S-C-RL respectively (e.g. in 26 GHz band) with the target UE for a wireless communication purpose, and the Secondary ISAC xNB has also setup and maintains S-S-RL (e.g. in 6.5 GHz band) with the same UE for a wireless sensing purpose. The S-S-RL may be based on a radar-type mechanism implemented by the Secondary ISAC xNB and can be used to enhance UE imaging management between the Master ISAC gNB and UE. For example, the Master ISAC gNB may monitor the UE images based on sensing feedback from the Secondary ISAC xNB, in order to achieve the benefit of “sensing assists sensing” via S-S-RL. The Master ISAC gNB may coordinate with the Secondary ISAC xNB about their mutual wireless sensing capability, resource, and operation status.

The Master ISAC gNB determines whether the S-S-RL is sufficient. If there is not a sufficient wireless sensing benefit for UE imaging management, the Master ISAC gNB triggers the “Secondary ISAC RAN node Modification Procedure” over Xn interface in block 1602. This may include sending a “Secondary ISAC RAN node Modification Request” message in block 1604 to the Secondary ISAC xNB that includes updated parameter info (e.g. expected new sensing frequency band 70 GHz, “sensing result info” report pattern, and/or a wireless sensing signal pattern etc.) for reconfiguring “assisting S-S-RL.”

The Secondary ISAC xNB admits the request from Master ISAC gNB in block 1606. The Secondary ISAC xNB may setup and maintain S-S-RL (e.g. in 70 GHz band), and replies with a “Secondary ISAC RAN node Modification Request Acknowledge” message in block 1608 to the Master ISAC gNB over Xn interface, and further performs the requested wireless sensing operations via S-S-RL (e.g. in 70 GHz band) with the target UE.

After obtaining the “sensing result info,” the Secondary ISAC xNB feeds back the “sensing result info” to the Master ISAC gNB via “ISAC RAN node Sensing Result Report Procedure” over Xn interface. This may include sending “ISAC RAN node Sensing Result Report” message in block 1610 to the Master ISAC gNB that includes the available “sensing result info.” Upon obtaining the “sensing result info”, the Master ISAC gNB may interpret, compile, and use them to assist the UE, imaging and attempt to achieve an additional wireless sensing benefit of “sensing assists sensing” from S-S-RL in block 1612. The Secondary ISAC xNB continues to perform wireless sensing towards the target UE via S-S-RL and report the available “sensing result info” to the Master ISAC gNB, until it is indicated to stop by either the Master ISAC gNB command or itself for any reason.

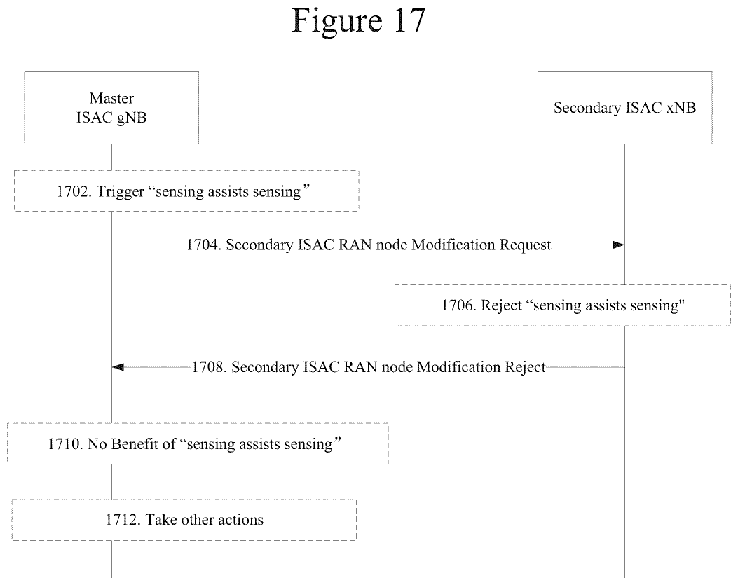

FIG. 17 shows another embodiment of communications for a modification request with sensing assists sensing. The Master ISAC gNB and Secondary ISAC xNB have setup and maintain M-C-RL and S-C-RL respectively (e.g. in 3.5 GHz band) with the target UE for a wireless communication purpose. The Secondary ISAC xNB has also setup and maintains S-S-RL (e.g. in 65 GHz band) with the same UE for a wireless sensing purpose. The S-S-RL is based on a radar-type mechanism implemented by the Secondary ISAC xNB and can be used to enhance UE imaging management between the Master ISAC gNB and UE. For example, the Master ISAC gNB can monitor the UE images based on sensing feedback from the Secondary ISAC xNB to achieve the benefit of “sensing assists sensing” via S-S-RL. The Master ISAC gNB may coordinate with the Secondary ISAC xNB about their mutual wireless sensing capability, resource, and operation status.

The Master ISAC gNB determines whether the S-S-RL is sufficient. If it is not sufficient, then there is no wireless sensing benefit for UE imaging management, so the Master ISAC gNB triggers the “Secondary ISAC RAN node Modification Procedure” over Xn interface in block 1702. This may include sending “Secondary ISAC RAN node Modification Request” message in block 1704 to the Secondary ISAC xNB and includes the necessary updated parameter info (e.g. expected new sensing frequency band 70 GHz, “sensing result info” report pattern, and/or wireless sensing signal pattern etc.) for reconfiguring “assisting S-S-RL.”

In this embodiment, the Secondary ISAC xNB rejects the request from Master ISAC gNB for local resource reasons in block 1706. This may include a reply with the “Secondary ISAC RAN node Modification Reject” message in block 1708 to the Master ISAC gNB over Xn interface. This stops the performing of wireless sensing operations via existing S-S-RL (e.g. in 65 GHz band) with the target UE, so there are no further benefits as in block 1710. Upon receiving the “Secondary ISAC RAN node Modification Reject” message, the Master ISAC gNB knows about the failure of reconfiguring “assisting S-S-RL” attempt with the Secondary ISAC xNB and may take other actions in block 1712.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A wireless communication method comprising:
providing, by a master node to a secondary node, an addition request for secondary sensing; and
receiving, by the master node from the secondary node, a sensing result report after acknowledging the addition request.

2. (canceled)

3. The method of claim 1, wherein a user equipment (UE) in a single connectivity (SC) is changed to a dual connectivity (DC) based on the addition request for secondary sensing.

4. The method of claim 3, wherein the addition request comprises the secondary sensing to be added to the secondary node.

5. The method of claim 1, wherein the secondary sensing comprises a secondary sensing radio link or a sensing function conducted by the secondary node.

6. The method of claim 5, wherein the secondary sensing radio link provides assistance with communication of the master node.

7. The method of claim 5, wherein the secondary sensing radio link provides assistance with sensing of the master node.

8. The method of claim 1, wherein the sensing result report is received periodically.

9. The method of claim 1, wherein the sensing result report is received on-demand.

10. The method of claim 1, wherein the sensing result report comprises data that has been sensed.

11. A wireless communication method comprising:
receiving, by a secondary node from a master node, an addition request for secondary sensing; and
providing, by the secondary node to the master node, a sensing result report after acknowledging the addition request.

12. (canceled)

13. The method of claim 11, wherein a user equipment (UE) in a single connectivity (SC) is changed to a dual connectivity (DC) based on the addition request for secondary sensing.

14. The method of claim 13, wherein the addition request comprises the secondary sensing to be added to the secondary node.

15. The method of claim 11, wherein the secondary sensing comprises a secondary sensing radio link or a sensing function conducted by the secondary node.

16. The method of claim 15, wherein the secondary sensing radio link provides assistance with communication of the master node.

17. The method of claim 15, wherein the secondary sensing radio link provides assistance with sensing of the master node.

18. The method of claim 11, wherein the sensing result report is sent periodically.

19. The method of claim 11, wherein the sensing result report is sent on-demand.

20. The method of claim 11, wherein the sensing result report comprises data that has been sensed.

21. A wireless communications apparatus comprising at least one processor and a memory, wherein the at least one processor is configured to read code from the memory and implement the method recited in claim 1.

22. (canceled)

23. A wireless communications apparatus comprising at least one processor and a memory, wherein the at least one processor is configured to read code from the memory and implement the method recited in claim 11.
